(19) United States
(12) Patent Application Publication
(10) Pub. No.: US 2005/0053781 A1
(43) Pub. Date: Mar. 10, 2005

(54) Method for producing a sheet material having a clear film serving as a wear layer, a peroxidically cross-linkable clear film serving as a wear layer for herogeneous floor coverings and floor coverings of this type

(76) Inventors: Bernd Fischer, Aspach (DE); Hann-Jorg Mauk, Mundelsheim (DE); Anja Graf, Freiberg (DE)

Correspondence Address: SUGHRUE MION, PLLC, 2100 PENNSYLVANIA AVENUE, N.W., SUITE 800, WASHINGTON, DC, 20037, US

(21) Appl. No.: 10/498,097

(22) PCT Filed: Nov. 28, 2002
(86) PCT No.: PCT/EP02/13443

(30) Foreign Application Priority Data
Dec. 11, 2001 (DE) 101 60 622.2

(51) Int. Cl. B05D 7/00; B32B 27/32

(52) U.S. Cl. 428/332; 427/407.1; 428/523

(57) ABSTRACT

The invention relates to a method for producing a multilayer sheet material while using a film, which is based on polyolefins, contains at least one organic peroxide compound, and serves as a wear layer. The invention also relates to a film, which is based on polyolefin and contains at least one peroxide compound. Finally, the invention relates to a floor covering, which comprises this film that is applied as a wear layer.

The invention relates to a method of producing a multilayer sheet material using a film based on polyolefin as the wear layer containing at least one organic peroxide compound, a film based on polyolefin containing at least one organic peroxide compound and a floor covering which has this applied film as the wear layer.

Thermoplastic floor coverings composed of multiple layers with a wear layer based on polyolefin are known in the state of the art (see, for example, European Patents EP A2-0 621 128 and EP-A2-0 780 207). However, such floor coverings have disadvantages in manufacturing in that first, an adhesive is required for bonding the wear layer to the substructure and second, special polymers such as ionomers are necessary for the wear layer in many cases. Furthermore, crosslinking of the wear layer and lamination of the wear layer onto the substrate are performed in multiple process steps. These disadvantages in the manufacture of such floor coverings which are known in the state of the art make a significant contribution toward cost.

Thus the object of the present invention is to provide a new film for use as a wear layer in particular for floor coverings and a new method for applying such films as the wear layer to carrier surfaces for the manufacture of multilayer floor coverings essentially without the use of adhesives, with traditional types of polyolefin as the binder in the wear layer and with simultaneous crosslinking of the wear layer and lamination of the wear layer onto the substrate of such a floor covering.

This object is achieved by the embodiments characterized in the claims. In particular a method of manufacturing a sheet material having at least two layers is provided, wherein a film based on polyolefin and containing at least one organic peroxide compound is applied as the wear layer to a second layer at a temperature of greater than or equal to the decomposition temperature of the organic peroxide compound forming a first layer.

The polyolefin contained in the film is not subject to any particular restriction and may be, for example, a homopolymer or copolymer of ethylenically unsaturated compounds or a mixture thereof such as types of polyethylene, ethylene methacrylate (EMA), ethylene butyl acrylate (EBA), ethylene vinyl acetate (EVA) copolymers, etc. In a preferred embodiment, the film contains a polyolefin of the polyethylene type with a melting point of <120° C.

The organic peroxide compound contained in the film includes not only individual compounds but may also contain a mixture of at least two such peroxide compounds with the provision that both the individual compounds as well as such a mixture must have a predetermined decomposition temperature which according to this invention is less than or equal to the temperature at which the film is applied to the second layer. Examples of organic peroxide compounds include 2,5-dimethyl-2,5-di-(t-butylperoxy)-hexane (DHBP) and 1,1-di-(t-butylperoxy)-3,3,5-trimethyl cyclohexane. The organic peroxide compound is preferably present in the film in an amount of 0.05 to 2.0 wt % based on the amount of polyolefin.

Furthermore, co-crosslinking agents may also be present in the film with the provision that these co-crosslinking agents are essentially stable at a temperature lower than the temperature prevailing when the film is applied to the second layer. Such co-crosslinking agents are preferably selected from the group consisting of di- and trimethacrylates, e.g., 1,4-butanediol dimethacrylate (1,4-BDMA), 1,3-butanediol dimethacrylate (1,3-BDMA), triethylene glycol dimethacrylate (TEDMA), trimethylolpropane trimethacrylate (TRIM), triallyl cyanurate (TAC) and triallyl isocyanurate (TAIC) and mixtures thereof. The co-crosslinking agent is preferably present in the film in an amount of 0.05 to 5 wt %, based on the amount of polyolefin. Furthermore, mineral oil, preferably (light) paraffinic mineral oil may also be present in an amount of up to 20 wt % based on the polyolefin.

The clear film or pigmented film used as the wear layer or top layer for the multilayer sheet material to be produced according to this invention may also contain conventional processing aids such as internal/external lubricants, e.g., from the group consisting of wax, e.g., metal salts; antistatics, e.g., GMS; antioxidants, e.g., phenol-hindered amines, etc. These processing aids are used in traditional amounts, e.g., 0.1 to 3 wt % based on the polyolefin.

An essential property of the inventive method is that the lamination, i.e., application of the film to the second layer and the peroxide crosslinking of the polyolefin contained in the film can be performed in a single operation, e.g., in an Auma, a double-belt press, etc. Furthermore, it has surprisingly been found that no adhesive is necessary in the inventive method to achieve excellent adhesion of the film to the second layer as the substrate. In addition, because of the peroxide crosslinking in contrast with the electron beam crosslinking used in the state of the art, the entire cross section of the film is crosslinked, which results in excellent material properties of the wear layer. All traditional types of polyethylene may be used as the binder in the film, including types of polyethylene that are not suitable as a wear layer in the absence of crosslinking so that the use of special polymers such as ionomers for the wear layer, as described in the state of the art, is no longer necessary.

When a clear film is used as the wear layer, i.e., the top layer, in general no fillers are embedded in the film. However, small quantities of silica may be used as the filler in this embodiment. When using a pigmented film as the wear layer or top layer, conventional fillers such as quartz powder, kaolin, talc, wood dust, dolomite, aluminum trihydroxide, precipitated silica, barium sulfate, chalk in addition to the usual pigments may be incorporated.

The amounts of fillers and pigments used are within the usual ranges and amount to as much as 70 wt %, for example, for fillers and up to 8 wt %, for example, for pigments based on the total formulation.

It is of course possible to emboss the wear layer, e.g., by using embossed release paper in the lamination process.

Another object of the present invention relates to the film itself which is described above and may be used as the wear layer or top layer for any sheet materials, e.g., as a wall covering, a floor covering, a sealing covering, a decorative film or synthetic veneer. Use as a wear layer for a floor covering is especially preferred.

The present invention also relates a (heterogeneous) floor covering having at least two layers, where the wear layer represents the film described above which can be produced by the inventive method described above. Such a multilayer floor covering has a wear layer with a thickness of preferably 0.06 to 1.0 mm.

The second layer, i.e., the substructure for such sheet materials to which the inventive film is applied, i.e., laminated is not subject to any restrictions. For example the inventive film may be laminated as the wear layer to a carrier layer as the second layer, with a backing layer of a chemically or mechanically foamed foam layer being optionally provided beneath the carrier layer in such a sheet material.

When using the sheet materials according to this invention as floor coverings, these floor coverings preferably consist of three, four or five layers, e.g., in a simple design that consists of one carrier layer as the second layer, a wear layer and a protective layer or a design consisting of a backing layer, optionally foamed, a middle or intermediate layer, a printed film or a nonwoven, including a transparent top layer. Of course the intermediate layer may also be pigmented for this purpose. A protective layer made of polymers or copolymers and/or waxes may also be provided above the wear layer. Examples of these unsaturated curable lacquer systems include polyacrylates, polymethacrylates, polyurethane blends thereof. However, carnuba wax, for example, may also be used. The protective layer should be manufactured of (co)polymers that are compatible with the wear layer.

The present invention is illustrated in greater detail by the following example.

The structure of the sheet material according to this invention consists of a crosslinked clear film laminated onto a BOPP film and an olefinic substrate with a high filler content arranged beneath that.

The formulation for the crosslinkable clear film is as follows:
75.0 g metallocene PE
2.0 g amorphous silica
0.8 g DHBP
1.0 g paraffinic mineral oil
0.8 g lubricant
0.2 g antioxidant
0.2 g antistatic

The formulation for the substrate is as follows:
46.0 g metallocene PE
48.0 g mineral filler
0.1 g antioxidant
0.15 g antistatic 1
0.25 g antistatic 2
0.4 g lubricant
5.0 g paraffinic mineral oil

The clear film is laminated onto the substrate at a drum temperature of approximately 190° C. in a rubber slab Auma.

1. Method for manufacturing a sheet material having at least two layers, a film based on polyolefin and containing at least one organic peroxide compound being applied as the wear layer to a second layer at a temperature greater than or equal to the decomposition temperature of the organic peroxide compound, forming a first layer, wherein the organic peroxide compound is present in an amount of 0.05 to 2.0 wt %, based on the amount of polyolefin in the film.

2. Method as claimed in claim 1, wherein the film based on polyolefin contains homopolymers or copolymers of ethylenically unsaturated compounds or a mixture thereof as binders.

3. Method as claimed in claim 2, wherein the binder is selected from polyethylene grades, ethylene methacrylate, ethylene butyl acrylate and ethylene vinyl acetate copolymers.

4. Method as claimed in any one of claims 1 through 3, wherein the film based on polyolefin contains at least one polyethylene which has a melting point of <120° C. as the binder.

5. Method as claimed in claim 1, wherein the organic peroxide compound is selected from DHBP and 1,1-di-(t-butylperoxy)-3,3,5-trimethylcyclohexane.

6. (canceled).

7. Method as claimed in claim 1, wherein a co-crosslinking agent is contained in the film.

8. Method as claimed in claim 6, wherein the co-crosslinking agent is selected from the group consisting of 1,4-BDMA, 1,3-BDMA, TEDMA, TRIM, TAC and TAIC and mixtures thereof.

9. Method as claimed in claim 6 or 7, wherein the co-crosslinking agent is present in the film in an amount of 0.05 to 5.0 wt %, in relation to the amount of polyolefin in the film.

10. Method as claimed in claim 1, wherein mineral oil is present in the film in an amount of up to 20 wt %, based on the amount of polyolefin in the film.

11. Method as claimed in claim 1, wherein the film contains one or more processing aids.

12. Film as defined in claim 1.

13. Floor covering having at least two layers, wherein the wear layer is formed from the film defined in claim 1.

14. Floor covering as claimed in claim 12, wherein the wear layer is 0.06 to 1.0 mm thick.
